(19) United States
(12) Patent Application Publication
(10) Pub. No.: US 2014/0143264 A1
(43) Pub. Date: May 22, 2014

(54) POLICY EVENT DRIVEN REMOTE DESKTOP RECORDING ACROSS A DATA NETWORK

(71) Applicant: George Runcie, San Jose, CA (US)

(72) Inventor: George Runcie, San Jose, CA (US)

(73) Assignee: KASEYA INTERNATIONAL LIMITED, St. Helier (JE)

(21) Appl. No.: 13/681,635

(22) Filed: Nov. 20, 2012

(51) Int. Cl. G06F 17/30; G06F 15/173

(52) U.S. Cl. 707/758; 709/224; 707/812; 707/E17.014; 707/E17.01

(57) ABSTRACT

Disclosed are an apparatus and method of remotely recording events occurring on a managed machine. One example method of operation may include identifying the managed machine operating in a communication network and transmitting a connection establishment message to the managed machine over the communication network. The method may also include receiving an acceptance message from the managed machine, transmitting a recording operation trigger to the managed machine, and receiving recorded information from the managed machine after the recording operation trigger has been invoked.

### TECHNICAL FIELD

This application relates to a method and apparatus of accessing a remotely managed machine via an administrator machine, and more specifically, establishing a connection and performing administrative functions to the managed machine over a remote connection, such as automatically recording remote desktop activity.

### BACKGROUND

User workstations or managed machines (computing devices) operate in a data communication network by communicating with other managed machines and/or administrative machines. Regardless of the status of the machine, the administrative machines operate to support ongoing communications and applications operating on the managed machines.

Accessing and executing commands on a managed machine through an administrative interface is a common method of updating, controlling, debugging and ensuring the continued seamless operation of the managed machine. However, in certain situations the actions performed by a managed machine may need to be observed, audited and logged to ensure the administrators are capable of determining specific details of the managed machine's past and present actions.

### SUMMARY

One embodiment of the present application may include a method of remotely recording events occurring on a managed machine. The method may include identifying the managed machine operating in a communication network, transmitting a connection establishment message to the managed machine over the communication network, and receiving an acceptance message from the managed machine. The method may also include transmitting a recording operation trigger to the managed machine, and receiving recorded information from the managed machine after the recording operation trigger has been invoked.

Another example embodiment may also include an apparatus configured to remotely record events occurring on a managed machine. The apparatus may include a processor configured to identify the managed machine operating in a communication network, and a transmitter configured to transmit a connection establishment message to the managed machine over the communication network. The apparatus may also include a receiver configured to receive an acceptance message from the managed machine. The transmitter is further configured to transmit a recording operation trigger to the managed machine, and the receiver is further configured to receive recorded information from the managed machine after the recording operation trigger has been invoked.

### BRIEF DESCRIPTION OF THE DRAWINGS

FIGS. 1A and 1B illustrate example network configurations, according to example embodiments of the present application.

FIG. 2 illustrates an example application communication session, according to an example method of operation of the present application.

FIG. 3 illustrates an example logic diagram of policy event driven remote desktop recording across a network.

FIG. 4 illustrates a remote management system according to example embodiments.

FIG. 5 illustrates a flow diagram of an example method according to an example embodiment of the present application.

FIG. 6 illustrates an example network entity device configured to store instructions, software, and corresponding hardware for executing the same, according to example embodiments of the present application.

### DETAILED DESCRIPTION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

According to example embodiments of the present application, an administrator may be any information technology (IT) systems administrator, IT service provider, and/or computer owner/operator who provides administrative functions to the computer devices, communication based connections and other network resources. A managed machine may be any network-connected computer device managed by the administrator. The managed machines may be connected directly to the administrator's machine, or, over a remote network connection. The managed machine or device may be a computer, laptop, mobile, wireless or cellular phone, a PDA, a table, a client a server or any device that contains a processor and/or memory, whether that processor or memory performs a function related to an embodiment of the application.

An administrator application may be a web-based application that permits the administrator to manage one or more remote managed machines. A secure network channel may be setup and established between the administrator machine and the remote managed machine via the administrator application. The secure network channel may provide connections over which data packets may be exchanged. The network channel may pass through a wide area network (WAN) (e.g. the Internet) or through a private local area network (LAN).

A agent application may be an application that includes a process running on the remote managed machine. The agent application accepts connections from the administrator application and assists with setting up a channel and transmitting and receiving commands and data. An administrator plug-in may be a browser plug-in operating in the context of the administrator application that connects with and interacts with the agent application of the managed machine over the existing network channel.

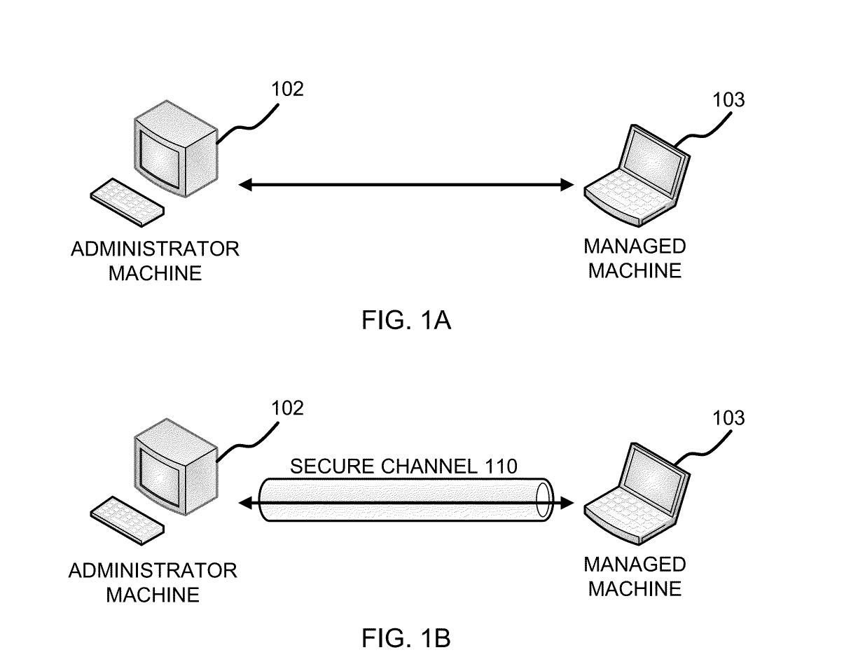

FIG. 1A illustrates an example network communication path between a managed machine and an administrator machine, according to example embodiments of the present application. Referring to FIG. 1A, an administrator machine 102 is in communication with a managed machine 103. The communication path may be over a WAN, such as, the Internet, or a LAN. The administrator machine 102 may be a server, computer or other computing device capable of providing a user interface to the administrator. The managed machine 103 may be a laptop, computer, personal digital assistant, smart phone or any other computer network compatible device capable of establishing a communication path or secure channel 110 with the administrator machine 102.

FIG. 1B illustrates an example network communication path between a managed machine 103 and administrator machine 102 that includes an established secure channel 100, according to example embodiments of the present application. Referring to FIG. 1B, the administrator initiates a connection via a secure channel to the remote managed machine 103. The agent application running on the managed machine accepts and acknowledges the connection establishment by transferring an acceptance message back to the administrator application. A secure connection may then be established between the managed machine 102 and the administrator machine 102.

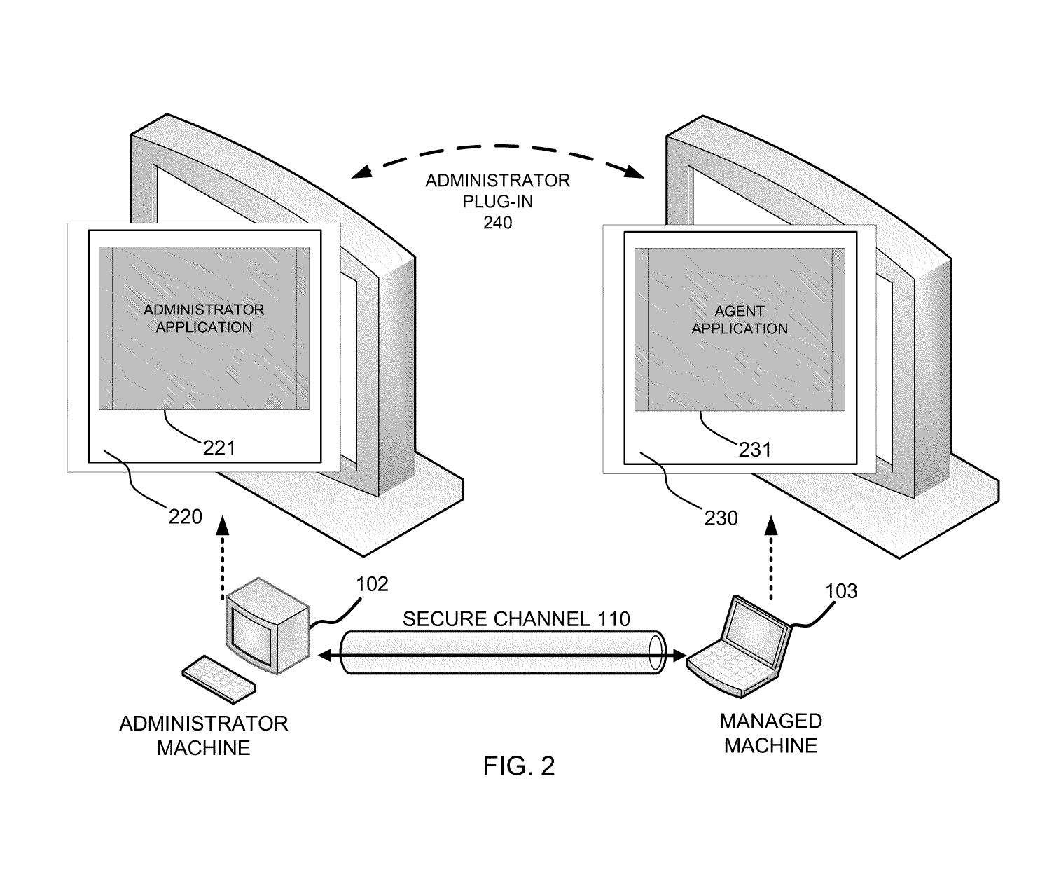

One example method of communicating between the administrator machine 102 and the managed machine 103 is described in detail below with reference to FIG. 2. Referring to FIG. 2, the administrator application 221 of the administrator's user interface 220 may include an administrator plug-in 240, which may be executed and run in a web browser of the user interface 220 on the administrator machine 102. The web browser may establish a connection through a proprietary secure channel 110 to a agent application 231 running on the application desktop 230 of the managed machine 103.

In operation, the administrator 102 browses for a particular managed machine 103 viewable from the administrator application 221. The administrator plug-in initiates a connection via a secure channel to a agent application 231 of the remote managed machine 103. The agent application 231 running on the managed machine accepts and acknowledges the connection establishment by transferring an acceptance message back to the administrator application 221. After session establishment, the administrator may receive a notification or web browser-based indicator that commands may now be received by the managed machine 103. The administrator may then launch a process to be executed on the managed machine 103.

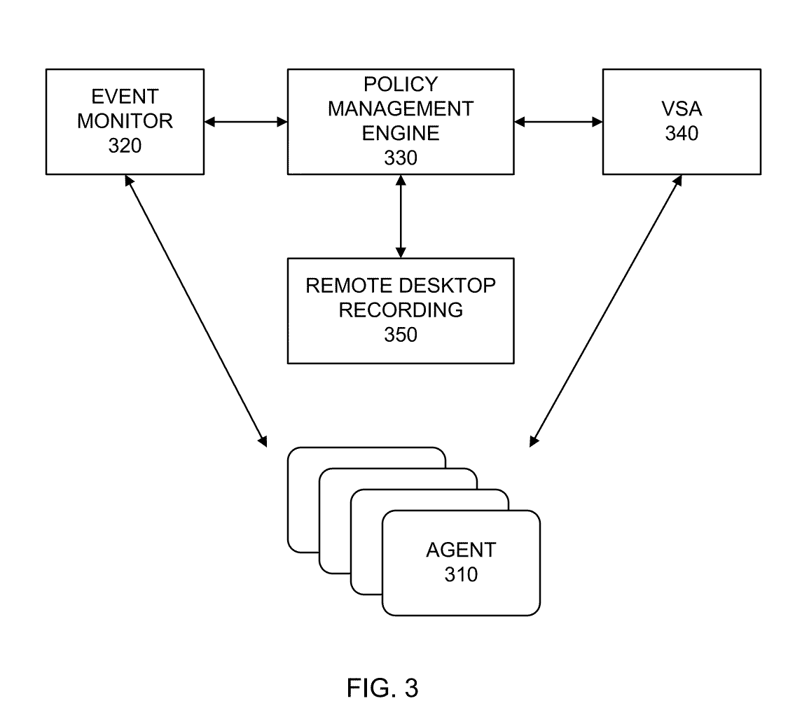

FIG. 3 illustrates an example logic diagram of policy event driven remote desktop recording operation performed across a network. Referring to FIG. 3, the agent 310 may be a particular application that is installed on the managed machine 103. The virtual systems administrator (VSA) 340 may connect with the agent application 310 across a wide area network (WAN), such as the Internet. A monitoring application or engine 320 may identify the activities or actions conducted by the managed machine 103 via collecting time logged application launches, data files that are updated to reflect managed machine usage, request messages and other messages transmitted from the managed machine 103, etc.

The VSA 340 may be a network portal, browser or other communication medium or device that is used to establish a connection from the administrator machine 102 to the remotely managed machine 103. The virtual system administrator (VSA) 340 may be an interface-based website that is accessible via a user terminal computer or other user interface device. The VSA interface is a functional interface that may be used to perform operations and/or functions and control program execution.

Policy-based recording will enable an administrator to automatically record remote desktop activity conducted on the managed machine 103 and allow the administrator machine 102 to search for a specific event/action that occurred during the recording period. For example, a policy that initiates a remote desktop recording operation when a connection establishment action is launched may permit the administrator account or device 102 to monitor whether a specific application has executed on the managed machine or in communication with the managed machine 103. The logging of the actions or events conducted on the managed machine 103 may be conducting during a live connection session over a secure channel 110.

Another policy action may include determining whether a customer has established a customer support ticket from a user portal interface on the managed machine 103. This policy may dictate recording when a user logs a support ticket, and the reason the ticket was created, etc. The ticket may be audited by the policy management engine 330 and certain keywords may be audited or parsed based on certain categories provided by the ticket creation user interface, such as “reason”, “purpose”, “importance level”, etc. Once the policy has been initiated, the recording operation may begin to log the user's actions, behaviors and other identification criteria to allow the recorded information to be used for identifying the particular managed machine 103.

According to example embodiments, examples of policies used to invoke a recording operation or other trigger operation may include a policy that invokes when a user initiates an Internet browser that automatically begins recording for a predetermined amount of time (e.g., 20 minutes). Also, certain recording operations may be conducted passively in the background and may be recalled when a certain operation occurs. For example, when an application crashes, the last five minutes of desktop recording leading up to the moment of the application crashing or terminating may be pre-recorded and invoked as a backup operation based on the application terminating prematurely. For example, desktop application recording may be configured to record all the active application processes all the time, however, only the last 5 minutes of ongoing recording may be stored in the memory. When an active remote connection begins between a managing machine and a managed machine, the recording may be invoked automatically until the remote session is terminated.

According to one example, a desktop recording trigger event may be pre-selected and configured on a remotely managed machine, then events would then be generated on the remote machines. If the event is one of the monitored event types (i.e., a particular application, etc.), then the remote machine would then invoke an alarm that would be sent to the VSA. As a result, an alarm message in the VSA would be processed and if a desktop recording policy has been assigned to process the alarm, the VSA would instruct the remote machine to begin recording for a specific amount of time.

According to one example embodiment, desktop activity recording may be initiated responsive to a remote management application being launched or accessed. For example, if a management application is initiated from an administer device 102 to connect to a managed machine 103, then a desktop recording process may begin automatically. As a result, the agent application 231 launches a script to start the recording operation. The script launches an executable which captures current desktop activities at a specified interval (e.g., every 1, 10, 30, 360 seconds, etc.). At the end of the recording interval, the screen shot images may be incorporated together into a single moving image file. For example, multiple JPEG images may be aligned together to create a single MPEG or AVI file type.

According to one example embodiment with reference to FIG. 3, the virtual systems administrator (VSA) 340 may be operating as portal or third party device that assigns work management policies to remote agent processes connected to the VSA 340 over a wide area network. For example, the VSA 340 may be setup to update and execute actions on remote agent applications operating on various different network machines. The policies used to dictate when a recording operation begins, ends and triggers may be dynamically provided to any of a plurality of agents 310 installed on the managed machines 103.

The remote agent processes 310 will monitor local system events and forward filtered events to an event monitor engine and/or application 320. The remote agent 310 may transfer the filtered events based on specified criteria established via one or more policies transmitted from the VSA 340 to the agent 310. For example, the VSA 340 may create a policy to only record activity on the managed machine 103 after a customer service ticket has been created and transmitted to the administrative machine 102. Other policies may include recording activity after a certain known application has been launched, especially one that is known to create customer problems and network service degradation. These policies may be transmitted as messages or data frames that include additional parameters, such as time intervals, application names, machine identifiers, addresses, network segments, IP addresses, etc. to the agents 310. As a result, the policies may in turn create filters to be used by the agent 310 when reporting events to the event monitor 320.

The event monitor 320 will process received system events from the agent(s) 310. The remote system events that are registered as part of a policy action will be forwarded to policy management engine 330. For example, if the policy requires that a particular application be executed prior to any recording actions being conducted on the managed machine 103, then those applications must be executed prior to the policy management engine 330 being notified of the recording operation. If an event/action is registered as part of a ‘Remote Desktop Recording’ policy action, then the remote desktop recording operation will be launched on the agent 310 that posted the particular event. For example, the VSA 340 may be monitoring and managing hundreds of agents 310. One agent may invoke the recording operation due to a particular application being launched on that particular agent 310 and its corresponding managed machine 103. Upon completion of the recording event, the recording file that is created which contains the recording information will be uploaded to the VSA 340. The recording file may include time information indicating when certain actions were performed, image data including screenshots of a user's computer at set intervals during the course of the recording session. The recording file may be created by the agent and uploaded to the monitor engine 320, and/or policy management engine 330 for reference purposes.

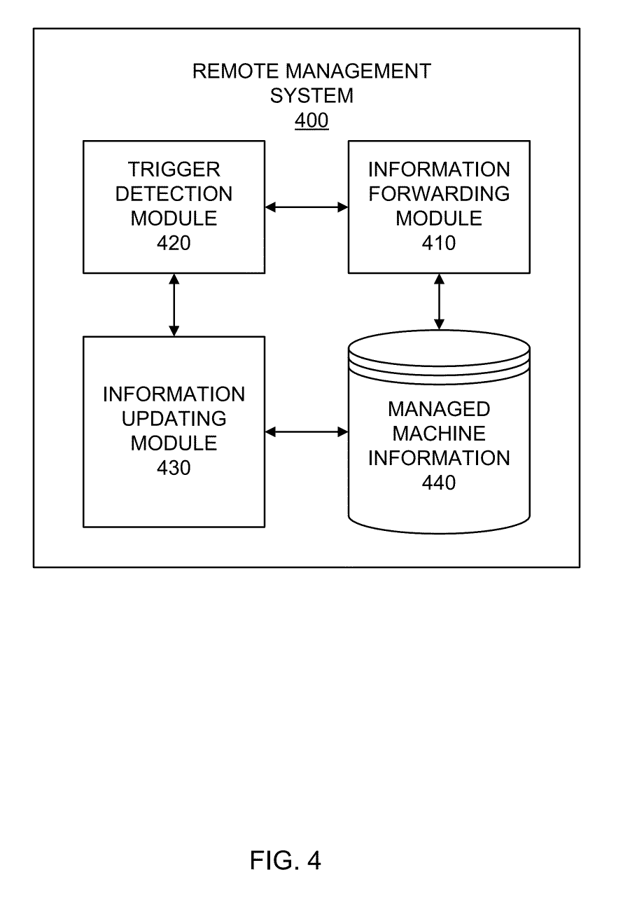

FIG. 4 illustrates an example remote management system 400 according to example embodiments of the present application. Referring to FIG. 4, the system 400 may provide a method of remotely recording events occurring on a managed machine. The method may include identifying the managed machine operating in a communication network by accessing a database 440 to identify the remotely managed machine. Next, a connection establishment message may be transmitted to the managed machine over the communication network via an information forwarding module 410. The method may also include receiving an acceptance message from the managed machine. The system 400 may further provide transmitting a recording operation trigger to the managed machine via the information forwarding module 410. A trigger detection module 420 may receive recorded information from the managed machine after the recording operation trigger has been invoked. The updated information may be reflected by a log file including the targeted recorded information recorded by the information updating module 430.

The recording operation trigger may be transmitted to an agent application operating on the managed machine by the information forwarding module 410. The information updating module 430 may also store the recording operation trigger in the managed machine, identify at least one event performed by the managed machine that matches the recording operation trigger, and initiate the recording operation responsive to identifying the at least one event performed by the managed machine. The recording operation trigger may include at least one of a specific application, an amount of time elapsed, and a specific message transmitted from the managed device. The recording operation may also cause a log file to be created that includes recorded information that occurred after the recording operation trigger has been invoked. The log file may be stored in a remote database for future reference purposes. Subsequent to the log file being created, the system 400 may identify at least one event of interest, retrieve the log file, and search the content of the log file for the at least one event of interest. Examples of the event of interest may include a particular application that was executed on the managed machine during a duration of the recording operation.

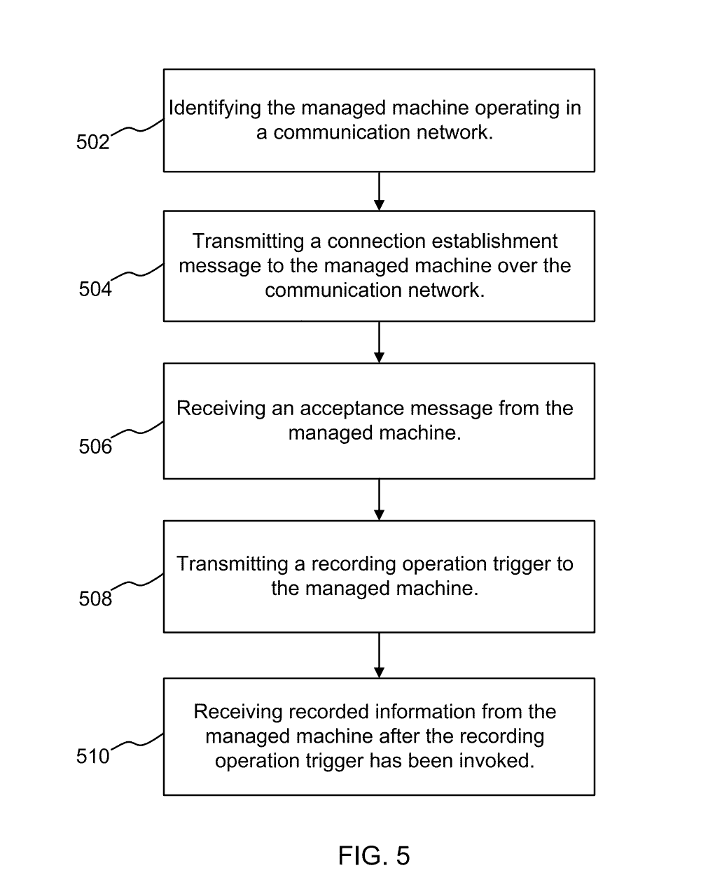

FIG. 5 illustrates an example flow diagram of an example method of operation according to example embodiments. Referring to FIG. 5, the flow diagram 500 may include a method of remotely recording events occurring on a managed machine. The method may include identifying the managed machine operating in a communication network, at operation 502, transmitting a connection establishment message to the managed machine over the communication network, at operation 504, receiving an acceptance message from the managed machine, at operation 506, transmitting a recording operation trigger to the managed machine, at operation 508 and receiving recorded information from the managed machine after the recording operation trigger has been invoked at operation 510.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

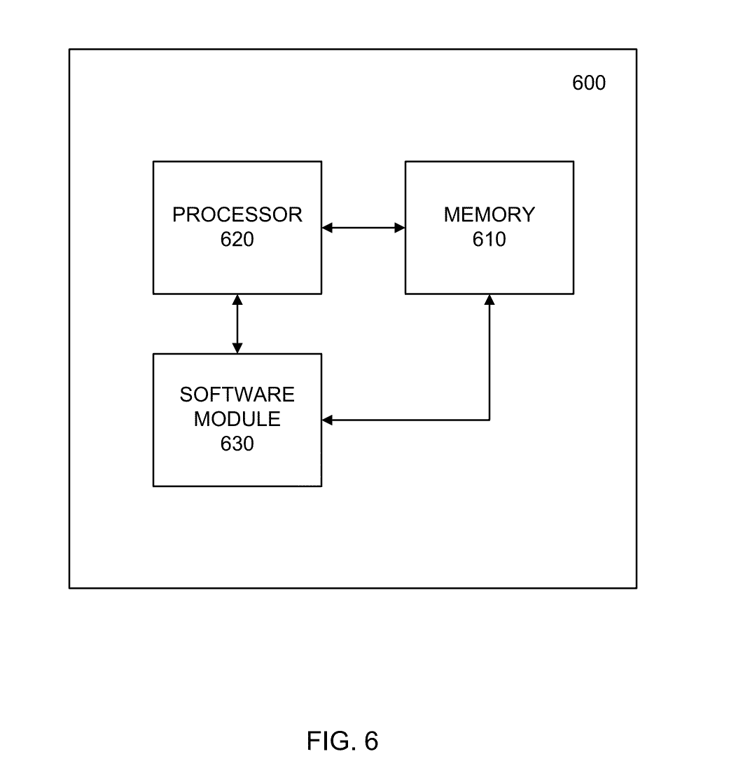

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 6 illustrates an example network element 600, which may represent any of the above-described network components 102 and 103, etc.

As illustrated in FIG. 6, a memory 610 and a processor 620 may be discrete components of the network entity 600 that are used to execute an application or set of operations. The application may be coded in software in a computer language understood by the processor 620, and stored in a computer readable medium, such as, the memory 610. The computer readable medium may be a non-transitory computer readable medium that includes tangible hardware components in addition to software stored in memory. Furthermore, a software module 630 may be another discrete entity that is part of the network entity 600, and which contains software instructions that may be executed by the processor 620. In addition to the above noted components of the network entity 600, the network entity 600 may also have a transmitter and receiver pair configured to receive and transmit communication signals (not shown).

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method of remotely recording events occurring on a managed machine, the method comprising:
identifying the managed machine operating in a communication network;
transmitting a connection establishment message to the managed machine over the communication network;
receiving an acceptance message from the managed machine;
transmitting a recording operation trigger to the managed machine; and
receiving recorded information from the managed machine after the recording operation trigger has been invoked.

2. The method of claim 1, wherein the recording operation trigger is transmitted to an agent application operating on the managed machine.

3. The method of claim 2, further comprising:
storing the recording operation trigger in the managed machine;
identifying at least one event performed by the managed machine that matches the recording operation trigger; and
initiating the recording operation responsive to identifying the at least one event performed by the managed machine.

4. The method of claim 3, wherein the recording operation trigger comprises at least one of a specific application, an amount of time elapsed, and a specific message transmitted from the managed device.

5. The method of claim 1, further comprising:
creating a log file that comprises recorded information that occurred after the recording operation trigger has been invoked; and
storing the log file in a remote database.

6. The method of claim 5, further comprising:
identifying at least one event of interest;
retrieving the log file; and
searching the content of the log file for the at least one event of interest.

7. The method of claim 6, wherein the at least one event of interest is based on a particular application that was executed on the managed machine during a duration of the recording operation.

8. An apparatus configured to remotely record events occurring on a managed machine, the apparatus comprising:
a processor configured to identify the managed machine operating in a communication network;
a transmitter configured to transmit a connection establishment message to the managed machine over the communication network; and
a receiver configured to receive an acceptance message from the managed machine, wherein the transmitter is further configured to transmit a recording operation trigger to the managed machine, and wherein the receiver is further configured to receive recorded information from the managed machine after the recording operation trigger has been invoked.

9. The apparatus of claim 8, wherein the recording operation trigger is transmitted to an agent application operating on the managed machine.

10. The apparatus of claim 9, further comprising:
a memory configured to store the recording operation trigger in the managed machine, and wherein the processor is further configured to identify at least one event performed by the managed machine that matches the recording operation trigger, and initiate the recording operation responsive to identification of the at least one event performed by the managed machine.

11. The apparatus of claim 10, wherein the recording operation trigger comprises at least one of a specific application, an amount of time elapsed, and a specific message transmitted from the managed device.

12. The apparatus of claim 8, wherein the processor is further configured to create a log file that comprises recorded information that occurred after the recording operation trigger has been invoked, and wherein a memory is further configured to store the log file in a remote database.

13. The apparatus of claim 12, wherein the processor is further configured to identify at least one event of interest, retrieve the log file, and search the content of the log file for the at least one event of interest.

14. The apparatus of claim 13, wherein the at least one event of interest is based on a particular application that was executed on the managed machine during a duration of the recording operation.

15. A non-transitory computer readable storage medium configured to store instructions that when executed cause a processor to perform remotely recording events occurring on a managed machine, the processor being further configured to perform:
identifying the managed machine operating in a communication network;
transmitting a connection establishment message to the managed machine over the communication network;
receiving an acceptance message from the managed machine;
transmitting a recording operation trigger to the managed machine; and
receiving recorded information from the managed machine after the recording operation trigger has been invoked.

16. The non-transitory computer readable storage medium of claim 1, wherein the recording operation trigger is transmitted to an agent application operating on the managed machine.

17. The non-transitory computer readable storage medium of claim 16, wherein the processor is further configured to perform:
storing the recording operation trigger in the managed machine;
identifying at least one event performed by the managed machine that matches the recording operation trigger; and
initiating the recording operation responsive to identifying the at least one event performed by the managed machine.

18. The non-transitory computer readable storage medium of claim 17, wherein the recording operation trigger comprises at least one of a specific application, an amount of time elapsed, and a specific message transmitted from the managed device.

19. The non-transitory computer readable storage medium of claim 15, wherein the processor is further configured to perform:
creating a log file that comprises recorded information that occurred after the recording operation trigger has been invoked; and
storing the log file in a remote database.

20. The non-transitory computer readable storage medium of claim 15, wherein the processor is further configured to perform:
identifying at least one event of interest;
retrieving the log file; and
searching the content of the log file for the at least one event of interest, and wherein the at least one event of interest is based on a particular application that was executed on the managed machine during a duration of the recording operation.
